(19) United States
(12) Patent Application Publication
(10) Pub. No.: US 2006/0097997 A1
(43) Pub. Date: May 11, 2006

(54) Method and system for capturing data using a digital pen

(76) Inventors: Shekhar Ramachandra Borgaonkar, Bangalore (IN); Prasenjit Dey, Silchar (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/971,433

(22) Filed: Oct. 21, 2004

(51) Int. Cl. G09G 5/00

(52) U.S. Cl. 345/179

(57) ABSTRACT

A data capturing system is provided. The data capturing system includes a digital pen and a color-coded medium. The color-coded medium contains color information. The digital pen is able to detect the color information and to determine at least one field information of the color-coded medium based on the detected color information when it moves over the color-coded medium.

### FIELD OF THE INVENTION

The invention relates generally to a digital pen, and more particularly to a system and method for capturing data using a digital pen.

### BACKGROUND OF THE INVENTION

With the widespread use of computers, telecommunication devices and other electronic devices, information data are normally stored, transmitted and displayed in electronic form. In order to store, transmit and display the information data in electronic form, the information data have to be entered manually into an electronic device such as a computer, or documents containing the information data have to be scanned. This makes the converting of the information data into electronic form cumbersome and inconvenient.

Form filling is a common and effective means of obtaining information. A form is a document with empty spaces for a user to fill in requested information. When a form is completed manually by the user, the information data provided by the user in the completed form is converted into electronic form by re-entering the information data into a computer. The process of re-entering the information data of the form into the computer is a time consuming and tedious process, especially when a large number of forms from many users are to be entered. The process of re-entering information data into the computer also leads to loss of accuracy as information may be incorrectly entered. Therefore, the cost of processing the forms is high since additional manpower are required to enter the information data of the forms into the computer and to verify the accuracy of the entries.

A digital pen allows a user to write on a medium, such as paper, and capture what was written electronically. Many digital pens use a digital camera to scan or capture images of the written data at regular intervals. The sequence of captured images can be processed using a processor to determine the strokes of the pen, and hence, the written data.

The digital pen may be used in conjunction with a special paper to allow the position of the pen on the special paper to be determined. The special paper has a pattern which uniquely identifies the position on the paper. The digital pen captures an image of a portion of the special paper using the digital camera, and identifies its position on the paper based on the pattern in the captured image.

Another type of digital pen determines its position using an acoustic transmitter. Such a digital pen is used together with an acoustic receiver. The acoustic transmitter in the digital pen transmits an acoustic signal to the acoustic receiver when a user writes on the medium using the digital pen. Based on the acoustic signal received by the receiver, the position of the digital pen is determined.

It is desirable to provide a system that uses a digital pen for capturing data from a form completed by a user. The digital pen preferably requires lower processing power and complexity for capturing the data and processing the captured data compared to any of the digital pens described above.

### SUMMARY OF THE INVENTION

In an embodiment, a data capturing system is provided. The data capturing system includes a digital pen and a color-coded medium. The color-coded medium contains color information. The digital pen is able to detect the color information and to determine at least one field information of the color-coded medium based on the detected color information when it moves over the color-coded medium.

### BRIEF DESCRIPTION OF THE DRAWINGS

The embodiments of the invention will be better understood in view of the following drawings and the detailed description.

FIG. 2 shows the use of a combination of two colors for identifying each field of a form according to an embodiment of the invention.

FIG. 3 shows an example of a form having color-coded fields according to an embodiment of the invention.

FIG. 4 shows a block diagram for capturing data from a color-coded medium according to an embodiment of the invention.

### DETAILED DESCRIPTION OF THE INVENTION

FIG. 1 shows a digital pen 100 according to an embodiment. The digital pen 100 includes a housing 101, a color sensor 102, a position signal transmitter 103, an ink tip 104, a connection means (not shown) and a processor (not shown) arranged inside the housing 101.

A color sensor is a sensor which detects optical signals by contrast, true color or translucent index. True color sensors are based on one of the color models, such as Red-Blue-Green (RGB), Hue-Saturation-Brightness (HSB) and Cyan-Magenta-Yellow (CMY). The color sensor 102 according to the embodiment detects color information of a medium. In an embodiment, the color sensor 102 of the digital pen 100 is a RGB color sensor. Other types of color sensors may also be used in other embodiments. The color sensor 102 can be placed inside an optical housing (not shown) of the digital pen 100. The axis of the optical housing is parallel to the axis of the pen 100.

The position signal transmitter 103 is mounted near the ink tip 104 of the digital pen 100. The position signal transmitter 103 transmits a position signal to a position signal sensor or receiver (not shown). The receiver is placed at a fixed location, for example clipped to the medium the digital pen writes on, outside the digital pen 100. The receiver determines a position of the digital pen 100 based on the received position signal. It is also possible that the receiver transmits the received position signal to another device for determining the position of the digital pen 100.

In an embodiment, the position signal transmitter 103 is an electromagnetic signal transmitter. The electromagnetic signal transmitter transmits an electromagnetic signal as the position signal. In another embodiment, the position signal transmitter 103 is an acoustic signal transmitter. The acoustic signal transmitter transmits an acoustic signal as the position signal. An example of the acoustic signal transmitter is an ultrasonic signal transmitter which transmits an ultrasonic signal as the position signal.

The processor is housed within the housing 101 of the digital pen. The processor is adapted to process the color information detected by the color sensor 102, and to determine a field information of the medium corresponding to the detected color information. The processor may be implemented using a Digital Signal Processor (DSP) chip.

In another embodiment, the digital pen includes the ink tip 104 for writing or drawing on a medium. An ink forming element (not shown) housed inside the pen housing 101 normally supplies ink to the ink tip 104. Examples of an ink forming element includes but not limited to ink cartridges and any kind of ink refills for ball-point pens. As the user moves the pen 100 over the medium with the ink tip 103 contacting the medium, ink flows from the ink forming element through the ink tip 103 onto the medium. Data provided on the medium refers to any markings formed on the medium using the digital pen 100, including any kind of handwritings, scribbles and drawings.

The digital pen 100 includes a connection means (not shown) for transferring data from the digital pen 100 to another device such as a computer. The computer upon receiving the data may further process the received data and store the processed data in a storage medium or display the processed data on a display screen. In one embodiment, the connection means connects to the other device using a wireless connection such as radio frequency (RF) or Infrared. An example of a RF connection means is Bluetooth. In another embodiment, the connection means connects to the other device using a wired connection such as a serial port, a parallel port or a Universal Serial Bus (USB).

The digital pen 100 may include a storage medium, such as a memory unit, to store detected color information or field information of the medium in another embodiment. The storage medium may also store position data of the digital pen 100 received from the position signal receiver. The information stored in the storage medium can be transmitted to another device via the connection means.

In an embodiment, the digital pen is used in conjunction with a color-coded medium as a data capturing system. The color-coded medium refers to paper or any other medium which the digital pen writes on. The color-coded medium includes printed color information. The color information can be printed on the medium using standard color printers, and normally includes one or more colors. Invisible colors such as ultra-violet and infrared may be used in other embodiments.

The color information is printed on the medium such that it coincides with at least one field of the medium. A field refers to a specific information area in the medium. It may refer to an area where certain information is provided, or to an empty space for specific information to be entered by a user such as in form filling. When the color information is detected by the digital pen 100, information relating to the field can be determined.

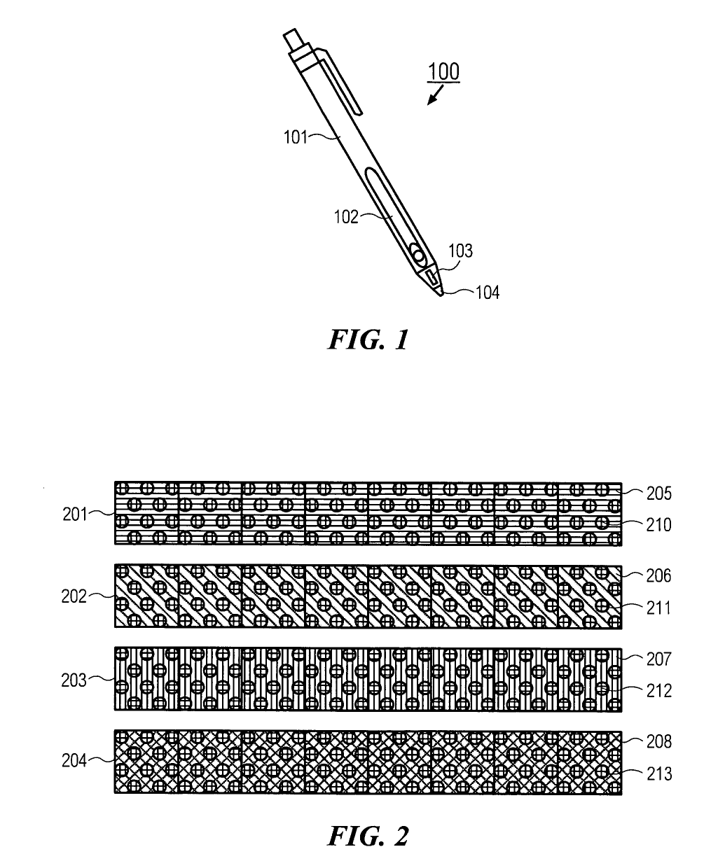

FIG. 2 shows an example of color information coinciding with four fields 201, 202, 203, 204 of a medium according to an embodiment. The color information of each field is a combination of two colors. The color information of a first field 201 includes a blue background 205 with evenly distributed yellow dots 210. The color information of a second field 202 includes a green background 206 with evenly distributed yellow dots 211. The color information of a third field 203 includes a purple background 207 with evenly distributed yellow dots 212. The color information of a fourth field 204 includes an orange background 208 with evenly distributed yellow dots 213.

It is also possible to use a different combination of colors for each field of the medium. The arrangement of the two colors for each field in FIG. 2 is for illustration purpose only. The two colors for each field may be arranged in a different manner. For example, the first field 201 may include alternating blue and yellow lines, or a blue background with evenly distributed yellow stripes. The color information for each field 201, 202, 203, 204 may also be represented by a single color.

The data capturing system further includes a position signal receiver (not shown) in an embodiment. The position signal receiver and the position signal transmitter 103 in the digital pen 100 forms a position sensing system. The position signal transmitter 103 transmits a position signal at a predetermined interval. The position signal receiver is operable to detect the position signal and to determine the position of the digital pen 100 based on the detected position signal.

The position signal receiver may be in a form of a clip-on device which is clipped to a portion of the medium when writing on the medium. Alternatively, the position signal receiver may be in a form of a clip board. The clip board includes a bay area where the medium can be affixed onto. When the user writes on the medium which is affixed on the bay area of the clip board, the position signal receiver detects the position signal and determines the position of the digital pen 100.

The data capturing system can be used in a form filling application in an embodiment. In this embodiment, the color-coded medium 200 is printed in a format of a form having various fields and spaces corresponding to each field for entering data by a user using the digital pen 100. According to this embodiment, information written or entered on the form can be directly captured into electronic form without having to re-enter the information into a computer.

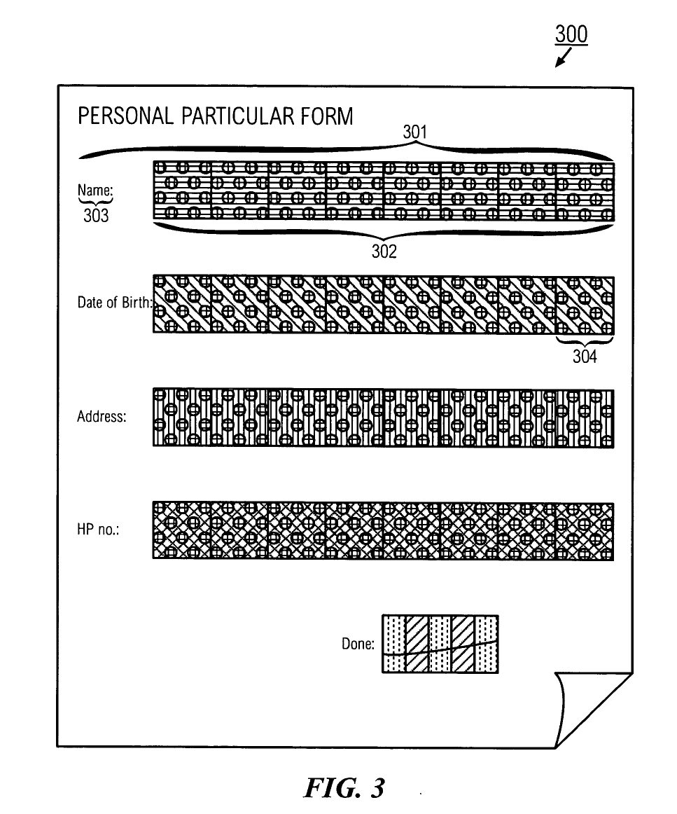

FIG. 3 shows an example of a form 300 in an embodiment. The form 300 includes fields 301 with corresponding spaces 302 for entering appropriate field data. The fields 301 are identified by Field Identities 303: Name, Date of Birth, Address, HP no. and Done. The form 300 may also include Form Identity and Form Instance. The Form Identity identifies the form type (e.g. a Personal Particular Form) and the Form Instance uniquely identifies the occurrence of the form type.

The spaces of each field for entering information include one or more blocks 304. Each block 304 of the same field has the same combination of two colors as color information. Accordingly, the Field Identities 303 Name, Date of Birth, Address, HP no. and Done are identified by detecting the color combination of the blocks 302. For example, the Field Identity Name is identified by a color combination of blue and yellow. The Field Identity Done is used to signal the end of form filling. The color combination of the Field Identity Done may also be used to identify the Form Identity and Form Instance. The Field Identity Done may be placed at the beginning of the form 300.

It is also possible to determine the Form Identity using the sequence of color combination of the fields. In the embodiment of the form in FIG. 3, the Form Identity “Personal Particular Form” may be determined by the field color combination sequence: blue-yellow, green-yellow, pink-yellow and orange-yellow.

It should be noted that the form 300 as shown in FIG. 3 is an example of a possible form which can be used in an embodiment. It is also possible to use a different form having different form types and fields in other embodiments. The fields may be identified using a single color as color information instead of the combination of two colors as shown in FIG. 2.

It is noted that in the embodiment when each field is identified using a combination of two different colors, the number of fields which can be identified is ^{N}C₂, where N is the number of available colors. For example, if 64 colors are available, the number of fields which can be identified is 2016. In the embodiment when each field is identified using a single color, the number of fields which can be identified is equal to the number of available colors. When each form has r number of fields, the number of forms which can be identified is ^{K}Pᵣ, where K=^{N}C₂.

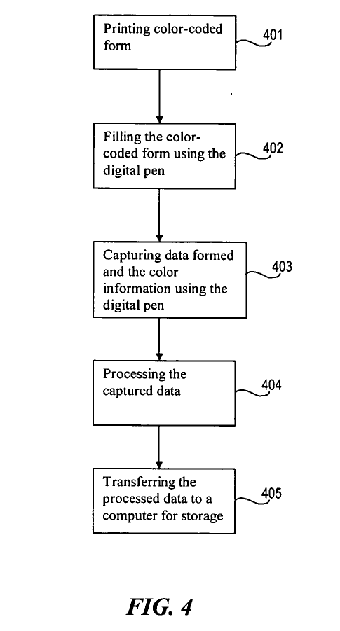

FIG. 4 shows a flow chart for capturing data from the color-coded medium using a digital pen according to an embodiment. Step 401 includes printing color information on a medium to form a color-coded medium. The color information may include color combinations as already illustrated in FIG. 2, or any color patterns or combination which allows at least one field information on the medium to be determined.

Step 402 includes writing on the color-coded medium using the digital pen. Step 402 can be illustrated with an example of a user filling up the form 300 of FIG. 3. After the fields Name, Date of Birth, Address and HP no. have been filled, the box of the field Done is struck off by the user to signify that the filling the form 300 has been completed.

Step 403 includes scanning the color information of the medium by the color sensor of the digital pen as the user writes on the medium. The detected color information includes colors and sequence of colors detected as already described above. Step 403 also includes detecting the position signal by the position signal receiver.

Step 404 includes processing the detected color information to determine the field information of the medium. At this step 404, the position signal receiver also determines the position of the digital pen based on the received position signal. It is also possible that information relating to the received position signal is transmitted to the processor of the digital pen for determining the position of the digital pen in another embodiment.

Step 405 includes transferring the determined field information and the position data of the digital pen to another device such as a computer or a personal digital assistant (PDA) using wired or wireless connection means. The position of the digital pen and the corresponding time of the digital pen represent the movement of the pen or pen strokes. The pen strokes correspond to the data written on the medium by the user using the digital pen. The handwritten data is associated with a corresponding field of the form based on the determined field information, and is stored accordingly. The position data may also be displayed on a display unit such as a screen of the computer or PDA as the captured handwritten data of the user.

The data capturing system described in the above embodiments allows an automatic means of capturing data provided by a user when filling a form, and eliminates the need to re-enter the data into the computer. Moreover, the digital pen of the data capturing system requires only a simple color sensor for detecting color information in order to determine the field information. The processing of color information is low in complexity. Therefore, a low-end processor can be used to implement the digital pen. This also results in the cost of the digital pen, and hence the data capturing system, to be low.

Although the present invention has been described in accordance with the embodiments as shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A data capturing system comprising:
a digital pen; and
a color-coded medium having color information thereon,
wherein the digital pen is able to detect the color information and determine at least one field information of the color-coded medium based on the detected color information when it moves over the color-coded medium.

2. The data capturing system of claim 1, wherein the digital pen comprises
a color sensor; and
a processor,
wherein the color information of the color-coded medium is detected using the color sensor, and
wherein the field information of the color-coded medium is determined using the processor.

3. The data capturing system of claim 2, further comprising a position sensing system for determining a position of the digital pen.

4. The data capturing system of claim 3, wherein the position sensing system comprises:
an electromagnetic transmitter mounted on the digital pen; and
an electromagnetic sensor,
wherein the electromagnetic sensor detects an electromagnetic signal transmitted by electromagnetic transmitter and determines the position of the pen based on the detected electromagnetic signal.

5. The data capturing system of claim 3, wherein the position sensing system comprises:
an acoustic transmitter mounted on the digital pen; and
an acoustic sensor,
wherein the acoustic sensor detects an acoustic signal transmitted by the acoustic transmitter and determines the position of the pen based on the detected acoustic signal.

6. The data capturing system of claim 5, wherein the acoustic transmitter is an ultrasonic transmitter for transmitting an ultrasonic signal, and the acoustic sensor is an ultrasonic sensor for receiving the ultrasonic signal.

7. The data capturing system of claim 2, wherein the color sensor is a Red Green Blue (RGB) sensor.

8. The data capturing system of claim 2, wherein the digital pen further comprises an ink forming element for forming a mark on the color-coded medium when the digital pen moves over the medium.

9. The data capturing system of claim 2, wherein the digital pen further comprises a connection means for transferring data from the digital pen to another device.

10. The data capturing system of claim 9, wherein the connection means comprises a Bluetooth connection.

11. The data capturing system of claim 9, wherein the connection means comprises a Universal Serial Bus (USB) connection.

12. The data capturing system of claim 1, wherein the color-coded medium is a paper having a plurality of colors printed thereon.

13. The data capturing system of claim 12, wherein the color information of the color-coded medium is a combination of at least two colors for each field of the medium.

14. The data capturing system of claim 13, wherein an identity of the medium is determined based on a sequence of color combination for each field of the color-coded medium.

15. A digital pen for capturing data from a color-coded medium having color information thereon, the digital pen comprises:
a color sensor for detecting the color information of the medium when the digital is moved over the medium;
a position signal transmitter for transmitting a position signal to a receiver; and
a processor for determining at least one field information of the medium based on the detected color information.

16. The digital pen of claim 15, wherein the position signal transmitter is an electromagnetic signal transmitter for transmitting an electromagnetic signal.

17. The digital pen of claim 15, wherein the position signal transmitter is an acoustic signal transmitter for transmitting an acoustic signal.

18. The digital pen of claim 17, wherein the acoustic signal transmitter is an ultrasonic signal transmitter.

19. The digital pen of claim 15, wherein the color sensor is a Red Green Blue (RGB) sensor.

20. The digital pen of claim 15, further comprising an ink forming element for forming a mark on the medium when the digital pen moves over the medium.

21. The digital pen of claim 15, further comprising a connection means for transferring data from the digital pen to another device.

22. The digital pen of claim 21, wherein the connection means comprises a Bluetooth connection.

23. The digital pen of claim 21, wherein the connection means comprises a Universal Serial Bus (USB) connection.

24. A method for capturing data from a color-coded medium having color information thereon using a digital pen, the method comprising:
detecting the color information of the medium when the digital pen is moved over the medium; and
determining at least one field information of the medium based on the detected color information.

25. The method of claim 24, further comprising:
determining a position of the digital pen;
determining movements of the digital pen based on the determined position of the digital pen; and
associating the movements of the digital pen with the filed information of the medium.
